(19) United States
(12) Patent Application Publication
(10) Pub. No.: US 2008/0110874 A1
(43) Pub. Date: May 15, 2008

(54) Substrate heating device

(75) Inventors: Naoto Hayashi, Nagano (JP); Hiroshi Yonekura, Nagano (JP); Koki Tamagawa, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/979,499

(22) Filed: Nov. 5, 2007

(30) Foreign Application Priority Data
Nov. 6, 2006 (JP) P.2006-300971

(51) Int. Cl. H05B 3/68

(52) U.S. Cl. 219/444.1; 219/468.1; 219/470

(57) ABSTRACT

A substrate heating device includes a ceramic plate on which a substrate is loaded, and first resistance heating bodies built in the ceramic plate, whereby the first resistance heating bodies are arranged on a same planar surface in substantially parallel with a substrate loading surface of the ceramic plate such that adjacent first resistance heating bodies are separated mutually and the first resistance heating bodies are constructed such that a temperature is controlled independently respectively, and also includes second resistance heating bodies built in the ceramic plate to heat portions of the ceramic plate positioned between the first resistance heating bodies.

This application claims priority to Japanese Patent Application No. 2006-300971, filed Nov. 6, 2006, in the Japanese Patent Office. The priority application is incorporated by reference in its entirety.

### TECHNICAL FIELD

The present disclosure relates to a substrate heating device. More particularly, the present disclosure relates to a substrate heating device having resistance heating bodies built in a ceramic plate to heat a substrate.

### RELATED ART

In the apparatuses such as the film forming apparatus for forming a film on a glass substrate, a semiconductor substrate, or the like, the etching apparatus for patterning the film formed on the substrate, and the like, the substrate heating device for loading the substrate thereon and heating the loaded substrate to a predetermined temperature is provided (see FIG. 1).

FIG. 1 is a sectional view of the substrate heating device in the related art.

By reference to FIG. 1, a substrate heating device 200 includes a base plate 201, a ceramic plate 202, an electrostatic plate 203, a plurality of resistance heating bodies 205 to 207, and power-supplying electrodes 211 to 216. The substrate heating device 200 is the device to secure a substrate 220 on the ceramic plate 202 by the electrostatic chuck and then heat the substrate 220 by a plurality of resistance heating bodies 205 to 207 via the ceramic plate 202 up to a predetermined temperature.

The base plate 201 is the platform on which the ceramic plate 202 is held. A pipeline 218 through which the cooling water circulates is formed in the base plate 201. The cooling water flowing through the pipeline 218 cools the ceramic plate 202 to control a temperature of a substrate loading surface 202A on which the substrate 220 is loaded.

The ceramic plate 202 is provided on the base plate 201. The ceramic plate 202 has the substrate loading surface 202A on which the substrate 220 is loaded.

The electrostatic plate 203 is an electrode that is formed like a thin film shape. The electrostatic plate 203 is built in a portion of the ceramic plate 202 positioned in close vicinity of the substrate loading surface 202A. When a voltage is applied to the electrostatic plate 203, the substrate 220 can be electrostatic-chucked (secured) on the ceramic plate 202.

FIG. 2 is a plan view of a resistance heating body provided to the substrate heating device shown in FIG. 1. In FIG. 2, the same reference symbols are affixed to the same constituent portions as the substrate heating device 200 shown in FIG. 1.

By reference to FIG. 1 and FIG. 2, a plurality of resistance heating bodies 205 to 207 are built in portions of the ceramic plate 202, which are positioned between the electrostatic plate 203 and a lower surface 202B of the ceramic plate 202, in substantially parallel with the substrate loading surface 202A of the ceramic plate 202.

The resistance heating body 205 is formed like a circular shape when viewed from the top, and is arranged in the center area of the ceramic plate 202. The resistance heating body 205 is connected to the power-supplying electrodes 213, 214 that are arranged in the portion of the ceramic plate 202 positioned below the resistance heating body 205. The power-supplying electrodes 213, 214 are connected electrically to a power supply 221. The power-supplying electrodes 213, 214 are the electrodes that supply an electric power to the resistance heating body 205 to heat the resistance heating body 205.

The resistance heating body 206 is formed like a ring shape. The resistance heating body 206 is arranged on the outside of the resistance heating body 205 away from the resistance heating body 205. The resistance heating body 206 is connected to the power-supplying electrodes 212, 215 that are arranged in the portion of the ceramic plate 202 positioned below the resistance heating body 206. The power-supplying electrodes 212, 215 are connected electrically to a power supply 222. The power-supplying electrodes 212, 215 are the electrodes that supply an electric power to the resistance heating body 206 to heat the resistance heating body 206.

The resistance heating body 207 is formed like a ring shape. The resistance heating body 207 is arranged on the outside of the resistance heating body 206 away from the resistance heating body 206. The resistance heating body 207 is connected to the power-supplying electrodes 211, 216 that are arranged in the portion of the ceramic plate 202 positioned below the resistance heating body 207. The power-supplying electrodes 211, 216 are connected electrically to a power supply 223. The power-supplying electrodes 211, 216 are the electrodes that supply an electric power to the resistance heating body 207 to heat the resistance heating body 207.

In this manner, since a plurality of resistance heating bodies 205 to 207 are connected electrically to different power supplies 221 to 223 respectively, a temperature of each of plural resistance heating bodies 205 to 207 can be controlled independently. Therefore, for example, when a film is formed on the substrate 220 in the plasma atmosphere, such film can be formed while differentiating a temperature of a portion of the substrate 220, which corresponds to an area where a plasma density is high, from a temperature of a portion of the substrate 220, which corresponds to an area where a plasma density is low. As a result, a dispersion of film quality of the film formed on the substrate 220 can be reduced (see Patent Literature 1, for example).

In FIG. 1 and FIG. 2, the resistance heating bodies 205 to 207 are illustrated in a simplified manner. But the actual resistance heating bodies 205 to 207 are a wiring pattern shown in FIG. 5 and described later.

[Patent Literature 1] Japanese Patent Unexamined Publication No. 2005-26120

However, in the substrate heating device 200 in the related art, a plurality of resistance heating bodies 205 to 207 are arranged in substantially parallel with the substrate loading surface 202A of the ceramic plate 202 in a state that these resistance heating bodies 205 to 207 are provided separately mutually. Therefore, it is difficult to heat sufficiently a ceramic plate portion S positioned between the resistance heating body 205 and the resistance heating body 206 and a ceramic plate portion T positioned between the resistance heating body 206 and the resistance heating body 207. As a result, such a problem existed that the substrate 220 cannot be heated to a predetermined temperature.

### SUMMARY

Exemplary embodiments of the present invention provide a substrate heating device capable of heating a substrate to a predetermined temperature.

According to an aspect of the present invention, there is provided a substrate heating device, which includes a ceramic plate having a first main surface on which a substrate is loaded, and a plurality of first resistance heating bodies built in the ceramic plate, wherein the plurality of first resistance heating bodies are arranged on a same planar surface in substantially parallel with the first main surface of the ceramic plate such that adjacent first resistance heating bodies are separated mutually, and the plurality of first resistance heating bodies are constructed such that a temperature is controlled independently respectively, and which includes at least one second resistance heating body built in the ceramic plate to heat portions of the ceramic plate positioned between the plurality of first resistance heating bodies.

According to the present invention, the second resistance heating body is built in predetermined portions of the ceramic plate. Therefore, portions of the ceramic plates positioned between a plurality of first resistance heating bodies can be heated. As a result, the substrate can be heated to a predetermined temperature.

According to another aspect of the present invention, there is provided a substrate heating device, which includes a ceramic plate on which a substrate is loaded; and a resistance heating body built in the ceramic plate to heat the ceramic plate; wherein the resistance heating body contains a first resistance heating body having an area that is substantially equal to a surface of the substrate contacting a first main surface of the ceramic plate, and arranged in substantially parallel with the first main surface of the ceramic plate, and a second resistance heating body arranged in a predetermined position between the first main surface of the ceramic plate and the first resistance heating body and/or between a surface of the ceramic plate on an opposite side to the first main surface and the first resistance heating body.

According to the present invention, the first resistance heating body that has an area that is substantially equal to the first main surface of the ceramic plate on which the substrate is loaded and is arranged in substantially parallel with the first main surface of the ceramic plate, and the second resistance heating body arranged in the predetermined position between the first main surface of the ceramic plate and the first resistance heating body and/or between the surface of the ceramic plate on the opposite side to the first main surface and the first resistance heating body are built in the ceramic plate. Therefore, the overall substrate is heated up to a substantially uniform temperature by the first resistance heating body, and also a portion of the ceramic plate whose temperature should be raised is heated by the second resistance heating body. As a result, the substrate can be heated to a predetermined temperature.

According to the present invention, the substrate can be heated up to a predetermined temperature.

Other features and advantages may be apparent from the following detailed description, the accompanying drawings and the claims.

### BRIEF DESCRIPTION OF THE DRAWINGS

FIG. 1 is a sectional view of a substrate heating device in the related art.

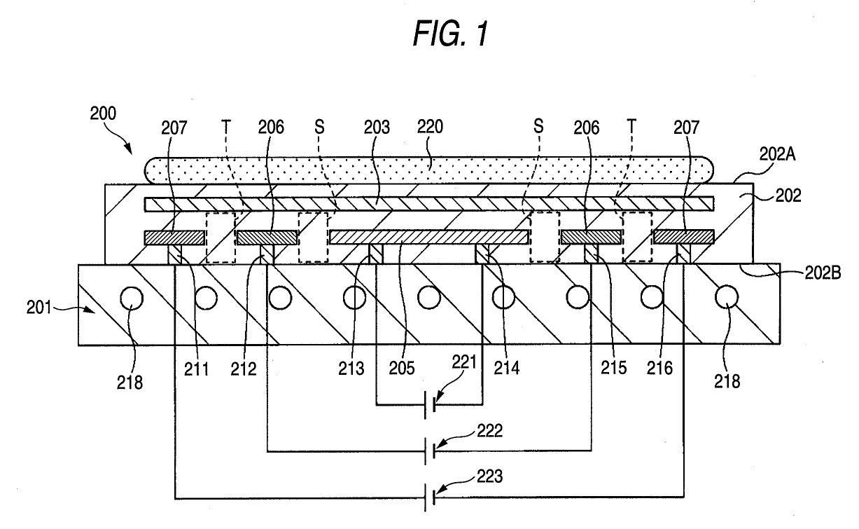

FIG. 2 is a plan view of a resistance heating body provided to the substrate heating device shown in FIG. 1.

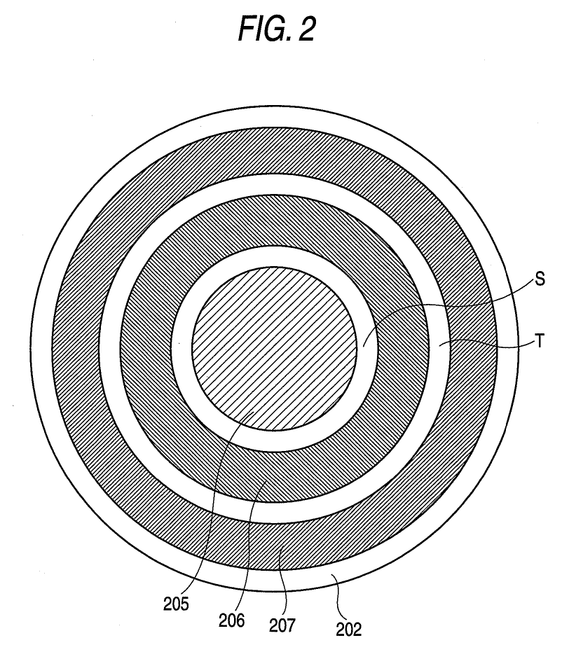

FIG. 3 is a sectional view of a substrate heating device according to a first embodiment of the present invention.

FIG. 4 is a plan view of a first resistance heating body provided to the substrate heating device shown in FIG. 3.

FIG. 5 is a view showing a concrete example of the first resistance heating body shown in FIG. 4.

FIG. 6 is a plan view of a second resistance heating body provided to the substrate heating device shown in FIG. 3.

FIG. 7 is a sectional view of a substrate heating device according to a second embodiment of the present invention.

FIG. 8 is a sectional view of a substrate heating device according to a third embodiment of the present invention.

FIG. 9 is a plan view of a third resistance heating body provided to the substrate heating device shown in FIG. 8.

FIG. 10 is a sectional view of a substrate heating device according to a fourth embodiment of the present invention.

FIG. 11 is a sectional view of a substrate heating device according to a fifth embodiment of the present invention.

FIG. 12 is a plan view of a first resistance heating body provided to the substrate heating device shown in FIG. 11.

FIG. 13 is a sectional view of a substrate heating device according to a sixth embodiment of the present invention.

FIG. 14 is a sectional view of a substrate heating device according to a seventh embodiment of the present invention.

FIG. 15 is a plan view of a third resistance heating body provided to the substrate heating device shown in FIG. 14.

### DETAILED DESCRIPTION

Next, embodiments of the present invention will be explained with reference to the drawings hereinafter.

### First Embodiment

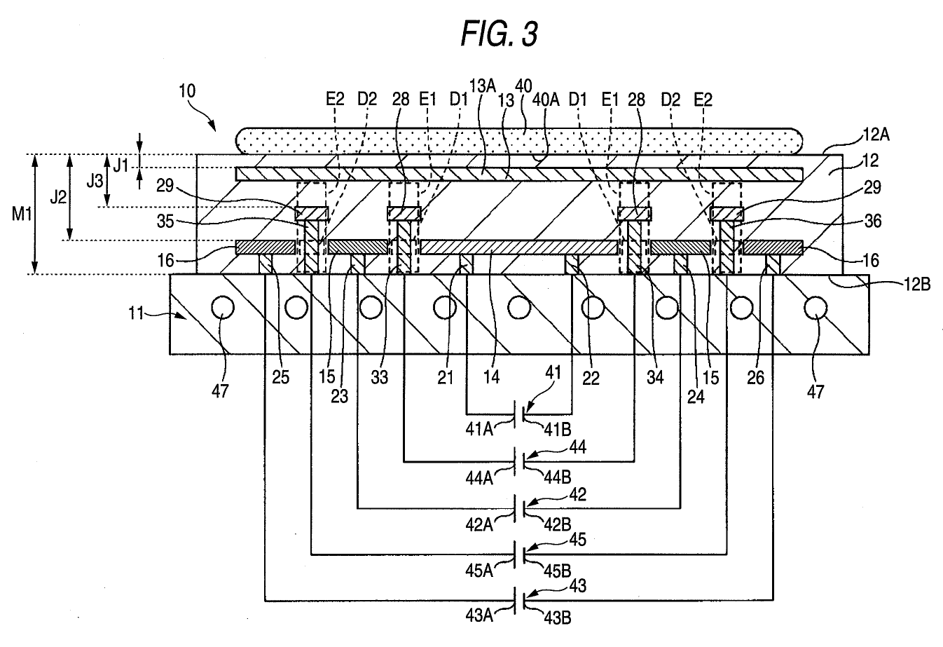

FIG. 3 is a sectional view of a substrate heating device according to a first embodiment of the present invention.

By reference to FIG. 3, a substrate heating device 10 of the first embodiment includes a base plate 11, a ceramic plate 12, an electrostatic electrode 13, first resistance heating bodies 14 to 16, electrodes 21 to 26, 33 to 36, second resistance heating bodies 28, 29, and power supplies 41 to 45.

The base plate 11 is the platform on which the ceramic plate 12 is held. A pipeline 47 through which the cooling water circulates is formed in the base plate 11. The cooling water flowing through the pipeline 47 cools the ceramic plate 12 to control a temperature of a substrate loading surface 12A (a first main surface of the ceramic plate 12).

The ceramic plate 12 is provided on the base plate 11. The ceramic plate 12 has the substrate loading surface 12A on which a substrate 40 is loaded. As the material of the ceramic plate 12, for example, nitride ceramic, carbide ceramic, oxide ceramic, etc. can be employed. A thickness M1 of the ceramic plate 12 can be set to 2 mm, for example.

As the substrate 40, for example, a glass substrate or a semiconductor substrate (e.g., semiconductor wafer, or the like) can be employed. In the present embodiment, the case where a circular semiconductor wafer is employed as the substrate 40 will be explained as an example.

The electrostatic electrode 13 is the electrode that is formed like a thin film shape, and is built in the portion of the ceramic plate 12 positioned between the substrate loading surface 12A of the ceramic plate 12 and the second resistance heating bodies 28, 29. An upper surface 13A of the electrostatic electrode 13 has an area that is substantially equal to a back surface 40A of the substrate 40. The electrostatic electrode 13 is set to a plus electric potential. Accordingly, the substrate 40 that is charged at a minus electric potential can be secured to the substrate loading surface 12A of the ceramic plate 12. The electrostatic electrode 13 is the electrode that secures the substrate 40 on the ceramic plate 12 by the electrostatic chuck. The electrostatic electrode 13 is connected electrically to a power supply (not shown) via the electrode (not shown) passing through the ceramic plate 12.

As the material of the electrostatic electrode 13, for example, tungsten can be employed. An interval J1 between the substrate loading surface 12A of the ceramic plate 12 and the upper surface 13A of the electrostatic electrode 13 can be set to 0.3 mm, for example. Also, a thickness of the electrostatic electrode 13 can be set to 10 μm, for example.

In the present embodiment, the single-pole electrostatic electrode 13 is explained by way of example. In this case, the electrostatic electrode having a first electrode portion, to which a plus electric potential is applied, and a second electrode portion, to which a minus electric potential is applied, (bipolar electrostatic electrode) may be employed instead of the single-pole electrostatic electrode 13.

The first resistance heating bodies 14 to 16 are built in the portion of the ceramic plate 12 positioned between a lower surface 12B of the ceramic plate 12 (a surface on the opposite side to the substrate loading surface 12A) and the second resistance heating bodies 28, 29. The first resistance heating bodies 14 to 16 are arranged on the same planar surface in substantially parallel with the substrate loading surface 12A of the ceramic plate 12 such that these first resistance heating bodies are separated mutually from the adjacent first resistance heating bodies 14 to 16.

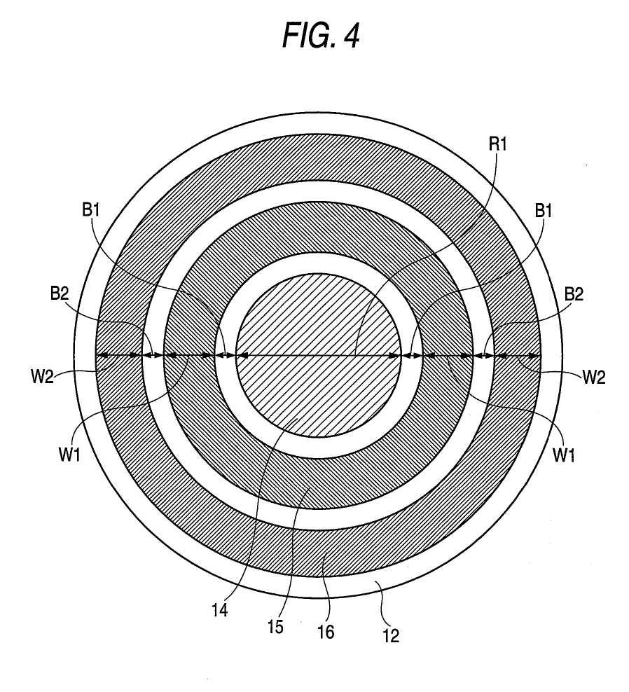

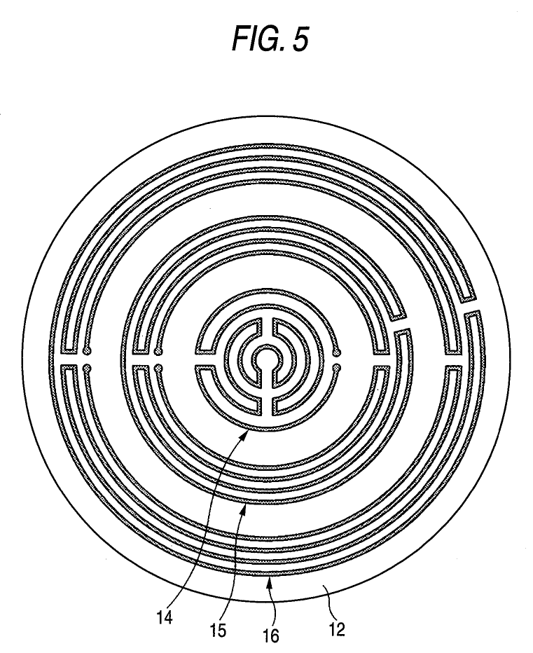

FIG. 4 is a plan view of a first resistance heating body provided to the substrate heating device shown in FIG. 3, and FIG. 5 is a view showing a concrete example of the first resistance heating body shown in FIG. 4.

By reference to FIG. 3 and FIG. 4, the first resistance heating body 14 is formed like a circular shape when viewed from the top, and is arranged in the center area of the ceramic plate 12. The first resistance heating body 14 is connected to the power-supplying electrodes 21, 22 connected electrically to the power supply 41. The first resistance heating body 14 generates a heat from the electric power that is supplied from the power supply 41 via the electrodes 21, 22. In FIG. 4, explanation of the first resistance heating body 14 is made by showing the simplified first resistance heating body 14. But the actual first resistance heating body 14 is a wiring pattern shown in FIG. 5.

The first resistance heating body 15 is formed like a ring shape. The first resistance heating body 15 is arranged on the outside of the first resistance heating body 14. The first resistance heating body 15 is connected to the power-supplying electrodes 23, 24 connected electrically to the power supply 42. The first resistance heating body 15 generates a heat from the electric power that is supplied from the power supply 42 via the electrodes 23, 24. In FIG. 4, explanation of the first resistance heating body 15 is made by showing the simplified first resistance heating body 15. But the actual first resistance heating body 15 is the wiring pattern shown in FIG. 5.

The first resistance heating body 16 is formed like a ring shape. The first resistance heating body 16 is arranged on the outside of the first resistance heating body 15. The first resistance heating body 16 is connected to the power-supplying electrodes 25, 26 connected electrically to the power supply 43. The first resistance heating body 16 generates a heat from the electric power that is supplied from the power supply 43 via the electrodes 25, 26. In FIG. 4, explanation of the first resistance heating body 16 is made by showing the simplified first resistance heating body 16. But the actual first resistance heating body 16 is the wiring pattern shown in FIG. 5.

In this manner, the first resistance heating bodies 14 to 16 are connected electrically to the separate power supplies 41 to 43 respectively. Therefore, temperatures of the first resistance heating bodies 14 to 16 can be controlled independently respectively.

When the semiconductor wafer whose diameter is 300 mm is employed as the substrate 40, a diameter R1 of the first resistance heating body 14 can be set to 86 mm, for example. In this case, widths W1, W2 of the first resistance heating bodies 15, 16 can be set to 30 mm, for example, respectively. Also, in this case, an interval B1 between the first resistance heating body 14 and the first resistance heating body 15 and an interval B2 between the first resistance heating body 15 and the first resistance heating body 16 can be set to 2 mm, for example, respectively. An interval J2 between the substrate loading surface 12A of the ceramic plate 12 and upper surfaces of the first resistance heating bodies 14 to 16 can be set to 1.3 mm, for example.

As the material of the first resistance heating bodies 14 to 16, for example, the semiconductor paste containing metallic particle or conductive ceramic contained to give the electrical conductivity, resin, solvent, thickener, etc. can be employed. As the metallic particle, for example, noble metal (gold, silver, platinum, palladium, or the like), lead, tungsten, molybdenum, nickel, or the like is preferable. As the conductive ceramic, for example, carbide of tungsten, molybdenum, or the like can be employed.

By reference to FIG. 3, the electrode 21 is provided to pass through the portion of the ceramic plate 12 positioned below the first resistance heating body 14. The electrode 21 is connected to the first resistance heating body 14 and is connected electrically to a plus terminal 41A of the power supply 41.

The electrode 22 is provided to pass through the portion of the ceramic plate 12 positioned below the first resistance heating body 14. The electrode 22 is connected to the first resistance heating body 14 and is connected electrically to a minus terminal 41B of the power supply 41. The electrodes 21, 22 are the power-supplying electrodes to supply an electric power to the first resistance heating body 14.

The electrode 23 is provided to pass through the portion of the ceramic plate 12 positioned below the first resistance heating body 15. The electrode 23 is connected to the first resistance heating body 15 and is connected electrically to a plus terminal 42A of the power supply 42.

The electrode 24 is provided to pass through the portion of the ceramic plate 12 positioned below the first resistance heating body 15. The electrode 24 is connected to the first resistance heating body 15 and is connected electrically to a minus terminal 42B of the power supply 42. The electrodes 23, 24 are the power-supplying electrodes to supply an electric power to the first resistance heating body 15.

The electrode 25 is provided to pass through the portion of the ceramic plate 12 positioned below the first resistance heating body 16. The electrode 25 is connected to the first resistance heating body 16 and is connected electrically to a plus terminal 43A of the power supply 43.

The electrode 26 is provided to pass through the portion of the ceramic plate 12 positioned below the first resistance heating body 16. The electrode 26 is connected to the first resistance heating body 16 and is connected electrically to a minus terminal 43B of the power supply 43. The electrodes 25, 26 are the power-supplying electrodes to supply an electric power to the first resistance heating body 16.

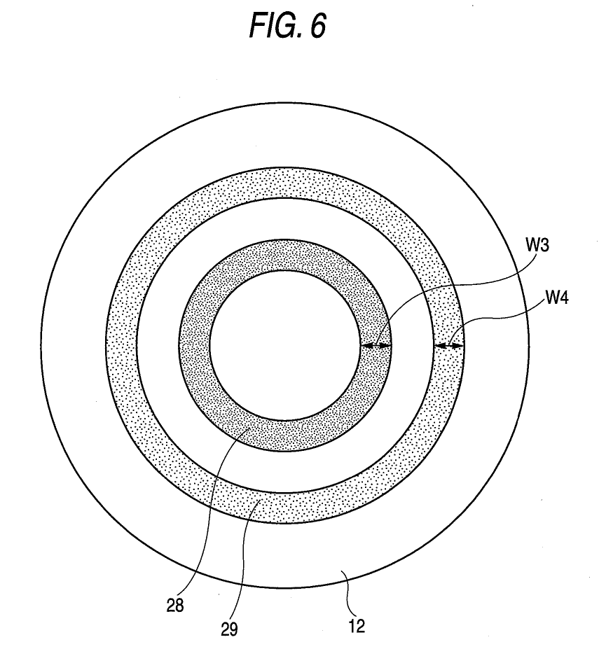

FIG. 6 is a plan view of a second resistance heating body provided to the substrate heating device shown in FIG. 3.

By reference to FIG. 3 and FIG. 6, the second resistance heating body 28 is formed like a ring shape. This second resistance heating body 28 is built in the portion of the ceramic plate 12 positioned between a ceramic plate portion D1, which is positioned between the first resistance heating body 14 and the first resistance heating body 15, and the electrostatic electrode 13. The second resistance heating body 28 is connected to the power-supplying electrodes 33, 34 connected electrically to the power supply 44. The second resistance heating body 28 generates a heat from the electric power that is supplied from the power supply 44 via the electrodes 33, 34. The second resistance heating body 28 is provided to heat a ceramic plate portion E1 (a portion of the ceramic plate 12 that is hard for the first resistance heating bodies 14 to 16 to heat) positioned between the first resistance heating body 14 and the first resistance heating body 15.

The second resistance heating body 29 is formed like a ring shape. This second resistance heating body 29 is built in the portion of the ceramic plate 12 positioned between a ceramic plate portion D2, which is positioned between the first resistance heating body 15 and the first resistance heating body 16, and the electrostatic electrode 13. The second resistance heating body 29 is connected to the power-supplying electrodes 35, 36 connected electrically to the power supply 45. The second resistance heating body 29 generates a heat from the electric power that is supplied from the power supply 45 via the electrodes 35, 36. The second resistance heating body 29 is provided to heat a ceramic plate portion E2 positioned between the first resistance heating body 15 and the first resistance heating body 16.

The second resistance heating bodies 28, 29 are connected electrically to the separate power supplies 44, 45 respectively. Therefore, temperatures of the second resistance heating bodies 28, 29 can be controlled independently respectively. As the concrete second resistance heating bodies 28, 29, for example, the wiring patterns that are similar to the first resistance heating bodies 14 to 16 (see FIG. 5) explained above can be employed.

In this manner, the second resistance heating body 28 is built in the portion of the ceramic plate 12 positioned between the ceramic plate portion D1 and the electrostatic electrode 13, and also the second resistance heating body 29 is built in the portion of the ceramic plate 12 positioned between the ceramic plate portion D2 and the electrostatic electrode 13. Therefore, the ceramic plate portion E1 positioned between the first resistance heating body 14 and the first resistance heating body 15 and the ceramic plate portion E2 positioned between the first resistance heating body 15 and the first resistance heating body 16 can be heated. As a result, the substrate 40 can be set to a predetermined temperature. Here, the expression “the substrate 40 can be set to a predetermined temperature” contains the case where the whole substrate 40 can be set to a substantially equal temperature, a temperature of the outer periphery of the substrate 40 is set higher than temperatures of remaining portions of the substrate 40 (a temperature distribution is given in a surface of the substrate 40), and the like. The predetermined temperature is the temperature that can be decided depending on the characteristic of the apparatus into which the substrate heating device 10 is incorporated (e.g., the etching apparatus, the film forming apparatus, or the like), the processing conditions, and the like.

When the diameter R1 of the first resistance heating body 14 is 86 mm, the widths W1, W2 of the first resistance heating bodies 15, 16 are 30 mm respectively, and the interval B1 between the first resistance heating body 14 and the first resistance heating body 15 and the interval B2 between the first resistance heating body 15 and the first resistance heating body 16 are 2 mm respectively, widths W3, W4 of the second resistance heating bodies 28, 29 can be set to 5 mm, for example, respectively. Also, an interval J3 between the substrate loading surface 12A of the ceramic plate 12 and upper surfaces of the second resistance heating bodies 28, 29 can be set to 0.8 mm, for example.

As the material of the second resistance heating bodies 28, 29, for example, the semiconductor paste containing metallic particle or conductive ceramic contained to give the electrical conductivity, resin, solvent, thickener, etc. can be employed. As the metallic particle, for example, noble metal (gold, silver, platinum, palladium, or the like), lead, tungsten, molybdenum, nickel, or the like is preferable. As the conductive ceramic, for example, carbide of tungsten, molybdenum, or the like can be employed.

By reference to FIG. 3, the electrode 33 is provided to pass through the portion of the ceramic plate 12 positioned below the second resistance heating body 28. The electrode 33 is connected to the second resistance heating body 28 and is connected electrically to a plus terminal 44A of the power supply 44.

The electrode 34 is provided to pass through the portion of the ceramic plate 12 positioned below the second resistance heating body 28. The electrode 34 is connected to the second resistance heating body 28 and is connected electrically to a minus terminal 44B of the power supply 44. The electrodes 33, 34 are the power-supplying electrodes to supply an electric power to the second resistance heating body 28.

The electrode 35 is provided to pass through the portion of the ceramic plate 12 positioned below the second resistance heating body 29. The electrode 35 is connected to the second resistance heating body 29 and is connected electrically to a plus terminal 45A of the power supply 45.

The electrode 36 is provided to pass through the portion of the ceramic plate 12 positioned below the second resistance heating body 29. The electrode 36 is connected to the second resistance heating body 29 and is connected electrically to a minus terminal 45B of the power supply 45. The electrodes 35, 36 are the power-supplying electrodes to supply an electric power to the second resistance heating body 29.

The power supplies 41 to 45 are provided on the outside of the base plate 11 and the ceramic plate 12. The power supply 41 has the plus terminal 41A and the minus terminal 41B. The plus terminal 41A is connected to the electrode 21, and the minus terminal 41B is connected to the electrode 22. The power supply 41 supplies an electric power to the first resistance heating body 14 via the electrodes 21, 22, and causes the first resistance heating body 14 to generate a heat.

The power supply 42 has the plus terminal 42A and the minus terminal 42B. The plus terminal 42A is connected to the electrode 23, and the minus terminal 42B is connected to the electrode 24. The power supply 42 supplies an electric power to the first resistance heating body 15 via the electrodes 23, 24, and causes the first resistance heating body 15 to generate a heat.

The power supply 43 has the plus terminal 43A and the minus terminal 43B. The plus terminal 43A is connected to the electrode 25, and the minus terminal 43B is connected to the electrode 26. The power supply 43 supplies an electric power to the first resistance heating body 16 via the electrodes 25, 26, and causes the first resistance heating body 16 to generate a heat.

The power supply 44 has the plus terminal 44A and the minus terminal 44B. The plus terminal 44A is connected to the electrode 33, and the minus terminal 44B is connected to the electrode 34. The power supply 44 supplies an electric power to the second resistance heating body 28 via the electrodes 33, 34, and causes the second resistance heating body 28 to generate a heat.

The power supply 45 has the plus terminal 45A and the minus terminal 45B. The plus terminal 45A is connected to the electrode 35, and the minus terminal 45B is connected to the electrode 36. The power supply 45 supplies an electric power to the second resistance heating body 29 via the electrodes 35, 36, and causes the second resistance heating body 29 to generate a heat.

According to the substrate heating device of the present invention, the second resistance heating body 28 is built in the portion of the ceramic plate 12 positioned between the ceramic plate portion D1, which is positioned between the first resistance heating body 14 and the first resistance heating body 15, and the electrostatic electrode 13, and also the second resistance heating body 29 is built in the portion of the ceramic plate 12 positioned between the ceramic plate portion D2, which is positioned between the first resistance heating body 15 and the first resistance heating body 16, and the electrostatic electrode 13. Therefore, the ceramic plate portion E1 positioned between the first resistance heating body 14 and the first resistance heating body 15 and the ceramic plate portion E2 positioned between the first resistance heating body 15 and the first resistance heating body 16 can be heated. As a result, the substrate 40 can be set to a predetermined temperature.

### Second Embodiment

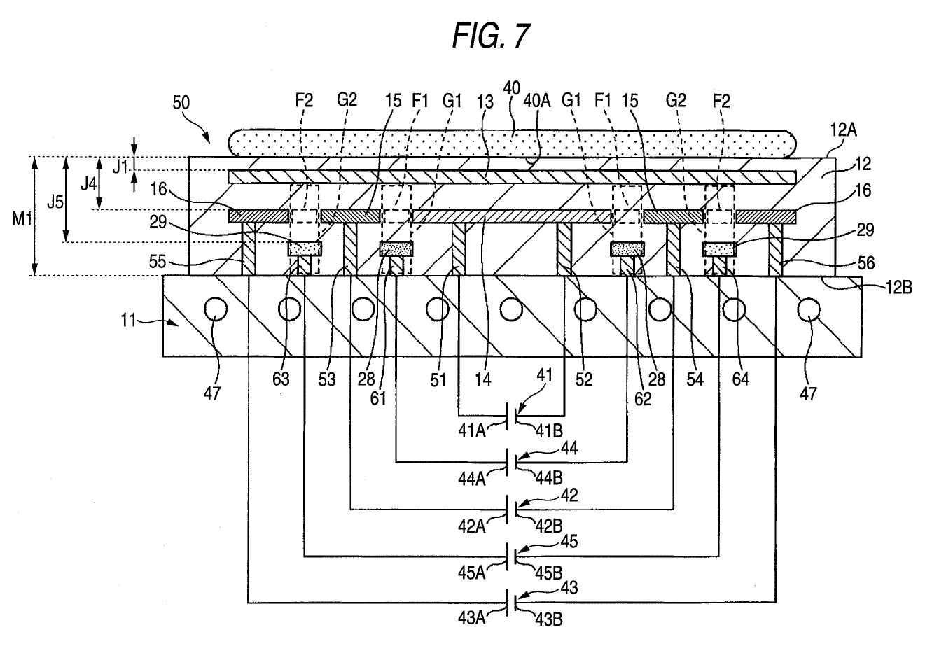

FIG. 7 is a sectional view of a substrate heating device according to a second embodiment of the present invention. In FIG. 7, the same reference symbols are affixed to the same constituent portions as the substrate heating device 10 according to the first embodiment.

By reference to FIG. 7, a substrate heating device 50 of the second embodiment is constructed similarly to the substrate heating device 10 of the first embodiment, except that electrodes 51 to 56, 61 to 64 are provided instead of the electrodes 21 to 26, 33 to 36 provided to the substrate heating device 10 and that the positions in which the first resistance heating bodies 14 to 16 and the second resistance heating bodies 28, 29 are provided in the first embodiment are changed respectively.

The first resistance heating bodies 14 to 16 are built in the portion of the ceramic plate 12 positioned below the electrostatic electrode 13 but over the second resistance heating bodies 28, 29. The first resistance heating bodies 14 to 16 are arranged on the same planar surface in substantially parallel with the substrate loading surface 12A of the ceramic plate 12 such that these first resistance heating bodies are separated mutually from the adjacent first resistance heating bodies 14 to 16.

The first resistance heating body 14 is connected to the power-supplying electrodes 51, 52 connected electrically to the power supply 41. The first resistance heating body 14 generates a heat from an electric power supplied from the power supply 41 via the electrodes 51, 52.

The first resistance heating body 15 is arranged on the outside of the first resistance heating body 14. The first resistance heating body 15 is connected to the electrodes 53, 54 connected electrically to the power supply 42. The first resistance heating body 15 generates a heat from an electric power supplied from the power supply 42 via the electrodes 53, 54.

The first resistance heating body 16 is arranged on the outside of the first resistance heating body 15. The first resistance heating body 16 is connected to the electrodes 55, 56 connected electrically to the power supply 43. The first resistance heating body 16 generates a heat from an electric power supplied from the power supply 43 via the electrodes 55, 56.

In this manner, the first resistance heating bodies 14 to 16 are connected electrically to the separate power supplies 41 to 43 respectively. Therefore, temperatures of the first resistance heating bodies 14 to 16 can be controlled independently respectively.

An interval J4 between the substrate loading surface 12A of the ceramic plate 12 and upper surfaces of the first resistance heating bodies 14 to 16 can be set to 0.8 mm, for example.

The second resistance heating body 28 is built in the portion of the ceramic plate 12 positioned between a ceramic plate portion F1, which is positioned between the first resistance heating body 14 and the first resistance heating body 15, and the lower surface 12B of the ceramic plate 12. The second resistance heating body 28 is connected to the power-supplying the electrodes 61, 62 connected electrically to the power supply 44. The second resistance heating body 28 generates a heat from the electric power that is supplied from the power supply 44 via the electrodes 61, 62. The second resistance heating body 28 is provided to heat a ceramic plate portion G1 positioned between the first resistance heating body 14 and the first resistance heating body 15.

The second resistance heating body 29 is built in the portion of the ceramic plate 12 positioned between a ceramic plate portion F2, which is positioned between the first resistance heating body 15 and the first resistance heating body 16, and the lower surface 12B of the ceramic plate 12. The second resistance heating body 29 is connected to the power-supplying electrodes 63, 64 connected electrically to the power supply 45. The second resistance heating body 29 generates a heat from the electric power that is supplied from the power supply 45 via the electrodes 63, 64. The second resistance heating body 29 is provided to heat a ceramic plate portion G2 positioned between the first resistance heating body 15 and the first resistance heating body 16. In this manner, since the second resistance heating bodies 28, 29 are connected electrically to the separate power supplies 44, 45 respectively, temperatures of the second resistance heating bodies 28, 29 can be controlled independently respectively.

As described above, the second resistance heating body 28 is built in the portion of the ceramic plate 12 positioned between the ceramic plate portion F1, which is positioned between the first resistance heating body 14 and the first resistance heating body 15, and the lower surface 12B of the ceramic plate 12, and also the second resistance heating body 29 is built in the portion of the ceramic plate 12 positioned between the ceramic plate portion F2, which is positioned between the first resistance heating body 15 and the first resistance heating body 16, and the lower surface 12B of the ceramic plate 12. Therefore, the ceramic plate portion G1 positioned between the first resistance heating body 14 and the first resistance heating body 15 and the ceramic plate portion G2 positioned between the first resistance heating body 15 and the first resistance heating body 16 can be heated. As a result, the substrate 40 can be set to a predetermined temperature.

An interval J5 between the substrate loading surface 12A of the ceramic plate 12 and upper surfaces of the second resistance heating bodies 28, 29 can be set to 1.3 mm, for example.

The electrode 51 is provided to pass through the portion of the ceramic plate 12 positioned below the first resistance heating body 14. The electrode 51 is connected to the first resistance heating body 14 and is connected electrically to the plus terminal 41A of the power supply 41.

The electrode 52 is provided to pass through the portion of the ceramic plate 12 positioned below the first resistance heating body 14. The electrode 52 is connected to the first resistance heating body 14 and is connected electrically to the minus terminal 41B of the power supply 41. The electrodes 51, 52 are the power-supplying electrodes to supply an electric power to the first resistance heating body 14.

The electrode 53 is provided to pass through the portion of the ceramic plate 12 positioned below the first resistance heating body 15. The electrode 53 is connected to the first resistance heating body 15 and is connected electrically to the plus terminal 42A of the power supply 42.

The electrode 54 is provided to pass through the portion of the ceramic plate 12 positioned below the first resistance heating body 15. The electrode 54 is connected to the first resistance heating body 15 and is connected electrically to the minus terminal 42B of the power supply 42. The electrodes 53, 54 are the power-supplying electrodes to supply an electric power to the first resistance heating body 15.

The electrode 55 is provided to pass through the portion of the ceramic plate 12 positioned below the first resistance heating body 16. The electrode 55 is connected to the first resistance heating body 16 and is connected electrically to the plus terminal 43A of the power supply 43.

The electrode 56 is provided to pass through the portion of the ceramic plate 12 positioned below the first resistance heating body 16. The electrode 56 is connected to the first resistance heating body 16 and is connected electrically to the minus terminal 43B of the power supply 43. The electrodes 55, 56 are the power-supplying electrodes to supply an electric power to the first resistance heating body 16.

The electrode 61 is provided to pass through the portion of the ceramic plate 12 positioned below the second resistance heating body 28. The electrode 61 is connected to the second resistance heating body 28 and is connected electrically to the plus terminal 44A of the power supply 44.

The electrode 62 is provided to pass through the portion of the ceramic plate 12 positioned below the second resistance heating body 28. The electrode 62 is connected to the second resistance heating body 28 and is connected electrically to the minus terminal 44B of the power supply 44. The electrodes 61, 62 are the power-supplying electrodes to supply an electric power to the second resistance heating body 28.

The electrode 63 is provided to pass through the portion of the ceramic plate 12 positioned below the second resistance heating body 29. The electrode 63 is connected to the second resistance heating body 29 and is connected electrically to the plus terminal 45A of the power supply 45.

The electrode 64 is provided to pass through the portion of the ceramic plate 12 positioned below the second resistance heating body 29. The electrode 64 is connected to the second resistance heating body 29 and is connected electrically to the minus terminal 45B of the power supply 45. The electrodes 63, 64 are the power-supplying electrodes to supply an electric power to the second resistance heating body 29.

According to the substrate heating device of the present embodiment, the second resistance heating body 28 is built in the portion of the ceramic plate 12 positioned between the ceramic plate portion F1, which is positioned between the first resistance heating body 14 and the first resistance heating body 15, and the lower surface 12B of the ceramic plate 12, and also the second resistance heating body 29 is built in the portion of the ceramic plate 12 positioned between the ceramic plate portion F2, which is positioned between the first resistance heating body 15 and the first resistance heating body 16, and the lower surface 12B of the ceramic plate 12. Therefore, the ceramic plate portion G1 positioned between the first resistance heating body 14 and the first resistance heating body 15 and the ceramic plate portion G2 positioned between the first resistance heating body 15 and the first resistance heating body 16 can be heated. As a result, the substrate 40 can be set to a predetermined temperature.

### Third Embodiment

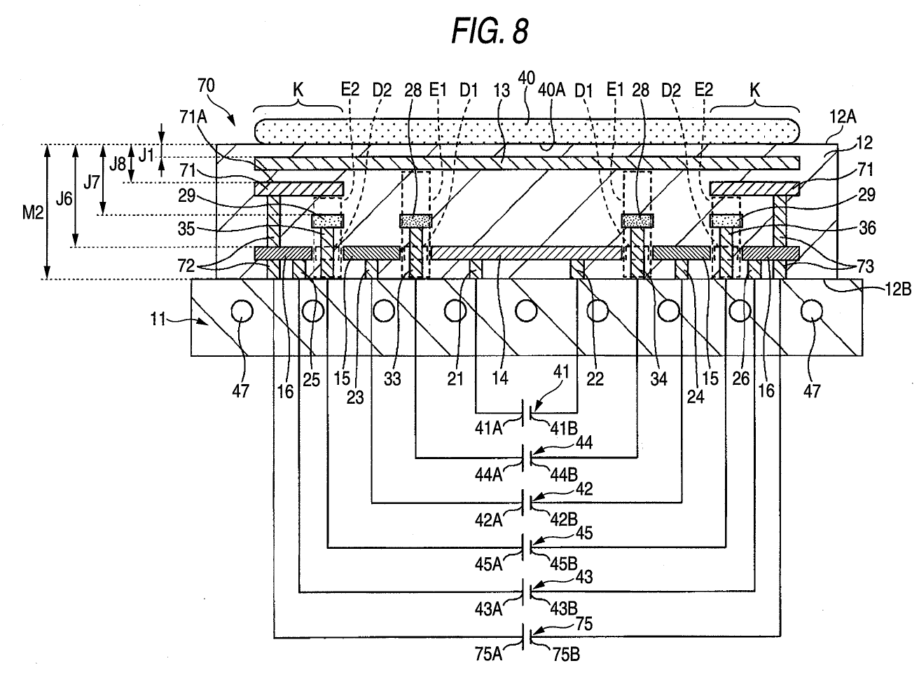

FIG. 8 is a sectional view of a substrate heating device according to a third embodiment of the present invention. In FIG. 8, the same reference symbols are affixed to the same constituent portions as the substrate heating device 10 according to the first embodiment. In FIG. 8, K denotes an outer peripheral portion of the substrate 40 (referred to as a “substrate outer peripheral portion K” hereinafter).

By reference to FIG. 8, a substrate heating device 70 of the third embodiment is constructed similarly to the substrate heating device 10 of the first embodiment, except that a third resistance heating body 71, electrodes 72, 73, and a power supply 75 are provided in addition to the configuration of the substrate heating device 10.

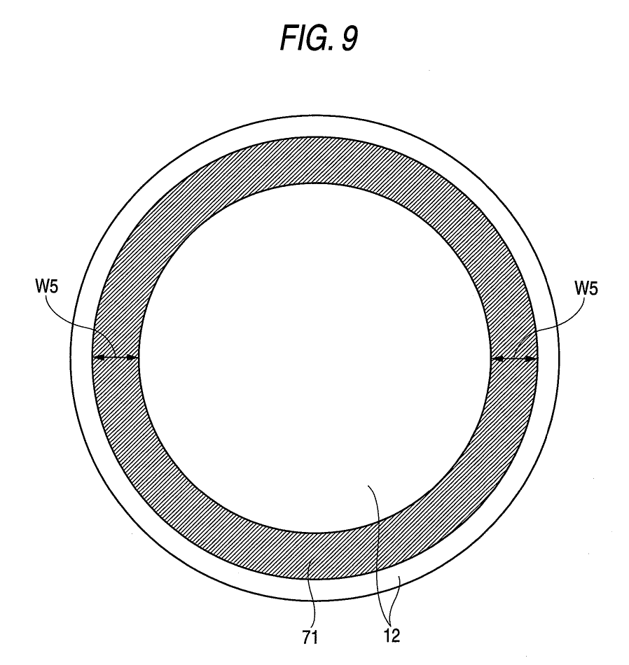

FIG. 9 is a plan view of a third resistance heating body provided to the substrate heating device shown in FIG. 8.

By reference to FIG. 8 and FIG. 9, the third resistance heating body 71 is formed like a ring shape. This third resistance heating body 71 is built in the portion of the ceramic plate 12 positioned over the second resistance heating body 29 but below the electrostatic electrode 13. The third resistance heating body 71 is arranged on the outer peripheral portion of the ceramic plate 12 such that the substrate outer peripheral portion K of the substrate 40 can be heated. In the case of the present embodiment, a predetermined position of the ceramic plate 12 in which the third resistance heating body 71 is arranged is the position that is located on the outer peripheral portion of the ceramic plate 12 and over the second resistance heating body 29 and below the electrostatic electrode 13.

The third resistance heating body 71 is connected to the power-supplying electrodes 72, 73 connected electrically to the power supply 75. The third resistance heating body 71 generates a heat from the electric power that is supplied from the power supply 75 via the electrodes 72, 73. As the concrete third resistance heating body 71, for example, the wiring patterns that are similar to the first resistance heating bodies 14 to 16 (see FIG. 5) explained above can be employed.

In this manner, in addition to the first resistance heating bodies 14 to 16 and the second resistance heating bodies 28, 29, the third resistance heating body 71 for heating the substrate outer peripheral portion K is built in the ceramic plate 12. Therefore, for example, in the case where the substrate heating device 70 is employed in the plasma CVD apparatus, when a plasma density over the substrate outer peripheral portion K is low, the substrate outer peripheral portion K can be heated up to a temperature higher than other portions of the substrate 40 by the substrate heating device 70. As a result, film quality of a film formed on the substrate 40 can be made substantially uniform not to depend on the plasma density.

As the material of the third resistance heating body 71, for example, the semiconductor paste containing metallic particle or conductive ceramic contained to give the electrical conductivity, resin, solvent, thickener, etc. can be employed. As the metallic particle, for example, noble metal (gold, silver, platinum, palladium, or the like), lead, tungsten, molybdenum, nickel, or the like is preferable. As the conductive ceramic, for example, carbide of tungsten, molybdenum, or the like can be employed.

An interval J8 between the substrate loading surface 12A of the ceramic plate 12 and an upper surface 71A of the third resistance heating body 71 can be set to 0.8 mm, for example. In this case, an interval J6 between the substrate loading surface 12A of the ceramic plate 12 and upper surfaces of the first resistance heating bodies 14 to 16 can be set to 1.8 mm, for example, an interval J7 between the substrate loading surface 12A of the ceramic plate 12 and upper surfaces of the second resistance heating bodies 28, 29 can be set to 1.3 mm, for example, and a thickness M2 of the ceramic plate 12 can be set to 3.5 mm, for example. Also, a width W5 of the third resistance heating body 71 can be set to 25 mm, for example.

By reference to FIG. 9, the electrode 72 is provided to pass through the portion of the ceramic plate 12 positioned below the third resistance heating body 71. The electrode 72 is connected to the third resistance heating body 71 and is connected electrically to a plus terminal 75A of the power supply 75.

The electrode 73 is provided to pass through the portion of the ceramic plate 12 positioned below the third resistance heating body 71. The electrode 73 is connected to the third resistance heating body 71 and is connected electrically to a minus terminal 75B of the power supply 75. The electrodes 72, 73 are insulated electrically from the first resistance heating body 16. The electrodes 72, 73 are the power-supplying electrodes to supply an electric power to the third resistance heating body 71.

The power supply 75 is provided on the outside of the base plate 11 and the ceramic plate 12. The power supply 75 has the plus terminal 75A and the minus terminal 75B. The plus terminal 75A is connected to the electrode 72, and the minus terminal 75B is connected to the electrode 73. The power supply 75 supplies an electric power to the third resistance heating body 71 via the electrodes 72, 73, and causes the third resistance heating body 71 to generate a heat.

According to the substrate heating device of the present embodiment, in addition to the first resistance heating bodies 14 to 16 and the second resistance heating bodies 28, 29, the third resistance heating body 71 for heating the substrate outer peripheral portion K is built in the ceramic plate 12. Therefore, for example, in the case where the substrate heating device 70 is employed in the plasma CVD apparatus, when a plasma density over the substrate outer peripheral portion K is low, the substrate outer peripheral portion K can be heated up to a temperature higher than other portions of the substrate 40 by the substrate heating device 70. As a result, film quality of a film formed on the substrate 40 can be made substantially uniform independent of the plasma density.

Also, the substrate heating device 70 of the present embodiment can possess the similar advantages as the substrate heating device 10 of the first embodiment.

In this case, the third resistance heating body 71 may be arranged in the portion of the ceramic plate 12 positioned over the first resistance heating bodies 14 to 16 but below the second resistance heating bodies 28, 29. Alternately, the third resistance heating body 71 may be arranged in the portion of the ceramic plate 12 positioned between the first resistance heating bodies 14 to 16 and the lower surface 12B of the ceramic plate 12.

Also, a predetermined position in which the third resistance heating body 71 should be arranged is changed depending on the manufacturing apparatus that is equipped with the substrate heating device 70. Therefore, an arrangement position of the third resistance heating body 71 is not limited to the arrangement position shown in FIG. 8.

### Fourth Embodiment

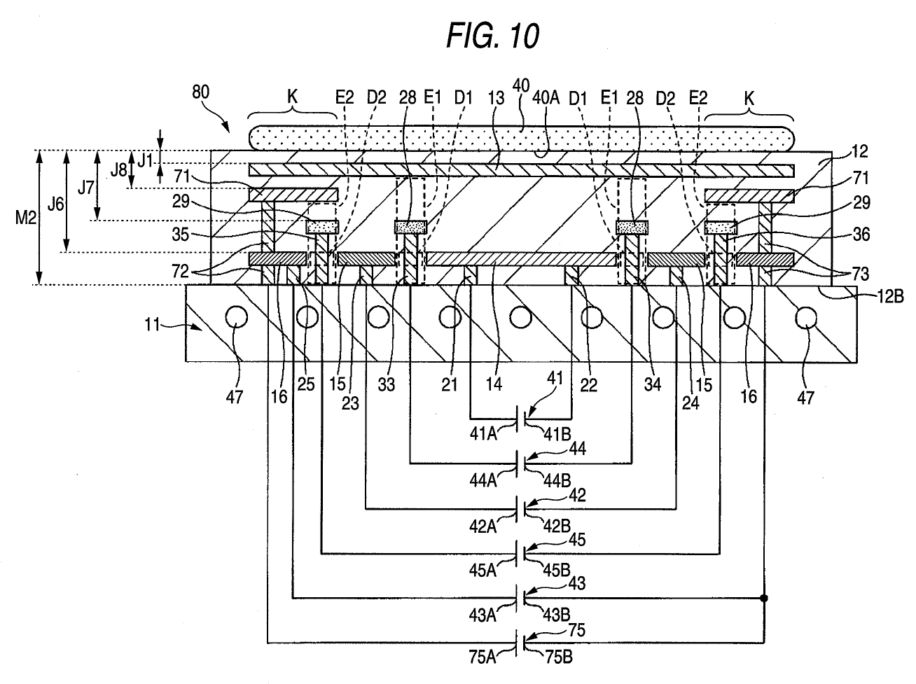

FIG. 10 is a sectional view of a substrate heating device according to a fourth embodiment of the present invention. In FIG. 10, the same reference symbols are affixed to the same constituent portions as the substrate heating device 70 according to the third embodiment.

By reference to FIG. 10, a substrate heating device 80 of the fourth embodiment is constructed similarly to the substrate heating device 70 of the third embodiment, except that the electrode 26 provided to the substrate heating device 70 of the third embodiment is removed and that the electrode 73 is connected to the first resistance heating body 16 and is connected electrically to the minus terminal 43B of the power supply 43.

Normally, a thermal conductivity of the electrodes 21 to 25, 33 to 36 is different from that of the ceramic plate 12 because the material of the electrodes 21 to 25, 33 to 36 is different from that of the ceramic plate 12. Therefore, a local temperature variation of the substrate 40 can be reduced smaller as the number of the electrodes 21 to 25, 33 to 36 formed in the ceramic plate 12 becomes smaller.

In the present embodiment, the electrode 73 is connected to the first resistance heating body 16 and also the electrode 73 is connected electrically to the minus terminal 43B of the power supply 43. Therefore, the electrode 26 shown in FIG. 8 can be omitted. As a result, the number of electrodes 21 to 25, 33 to 36 arranged in the ceramic plate 12 can be reduced.

According to the substrate heating device of the present embodiment, the electrode 73 is connected to the first resistance heating body 16 and also the electrode 73 is connected electrically to the minus terminal 43B of the power supply 43. Therefore, a local temperature variation of the substrate 40 can be reduced by reducing the number of the electrodes 21 to 25, 33 to 36 arranged in the ceramic plate 12.

In the present embodiment, the case where the electrode 73 is used as the common electrode to the first resistance heating body 16 and the third resistance heating body 71 is explained by way of example. However, when the electrode 73 is not connected to the first resistance heating body 16 but to the second resistance heating body 29 and the minus terminal 45B of the power supply 45, such electrode 73 may be used as the common electrode to the second resistance heating body 29 and the third resistance heating body 71. In this case, the electrode 36 can be removed from the constituent elements. Also, the electrode 72 is insulated electrically from the first resistance heating body 16.

### Fifth Embodiment

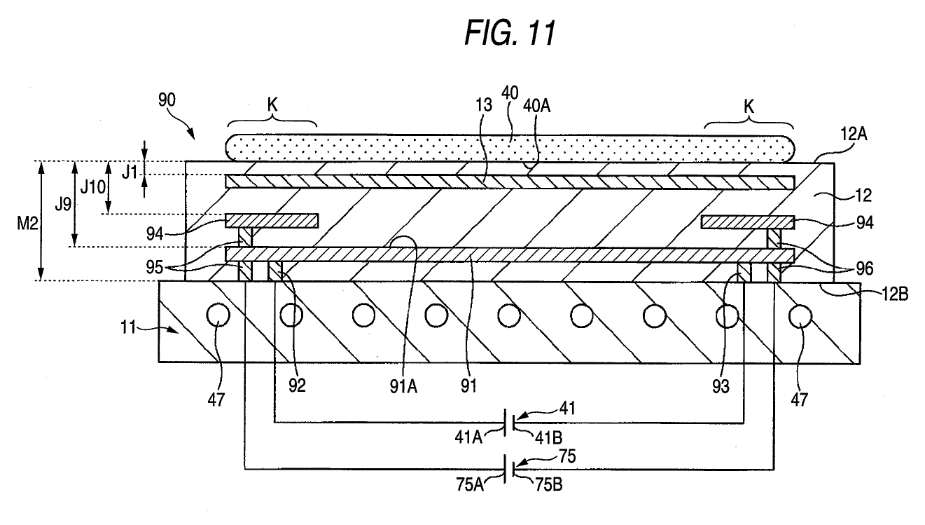

FIG. 11 is a sectional view of a substrate heating device according to a fifth embodiment of the present invention. In FIG. 11, the same reference symbols are affixed to the same constituent portions as the substrate heating device 80 according to the fourth embodiment.

By reference to FIG. 11, a substrate heating device 90 of the fifth embodiment is constructed similarly to the substrate heating device 80 of the fourth embodiment, except that the first resistance heating bodies 14 to 16, the second resistance heating bodies 28, 29, the third resistance heating body 71, the electrodes 21 to 26, 33 to 36, 72, 73, and the power supplies 42 to 45 are removed from the configuration of the substrate heating device 80 and that a first resistance heating body 91, a second resistance heating body 94, and electrodes 92, 93, 95, 96 are provided.

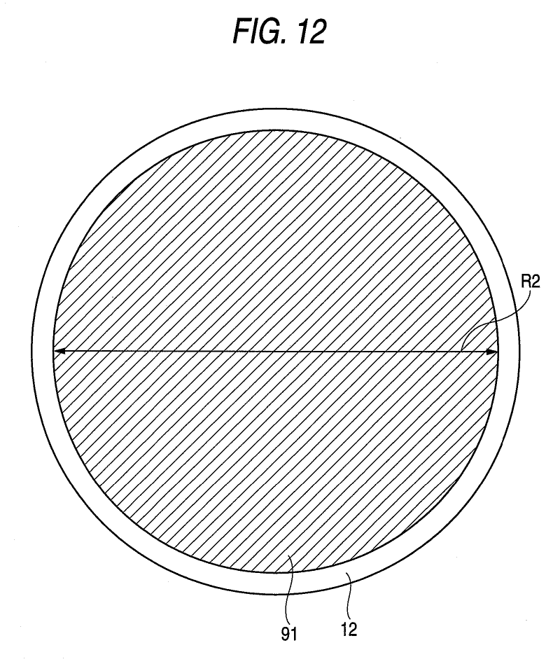

FIG. 12 is a plan view of a first resistance heating body provided to the substrate heating device shown in FIG. 11.

By reference to FIG. 11 and FIG. 12, the first resistance heating body 91 is built in the portion of the ceramic plate 12 positioned between the second resistance heating body 94 and the lower surface 12B of the ceramic plate 12. The first resistance heating body 91 is arranged in substantially parallel with the substrate loading surface 12A of the ceramic plate 12. The first resistance heating body 91 is formed like a circular shape when viewed from the top, and has an area that is almost equal to the back surface 40A of the substrate 40 contacting the substrate loading surface 12A of the ceramic plate 12. An interval J9 between the substrate loading surface 12A of the ceramic plate 12 and an upper surface 91A of the first resistance heating body 91 can be set to 1.5 mm, for example. Also, when a diameter of the substrate 40 is 300 mm, a diameter R2 of the first resistance heating body 91 can be set to 295 mm, for example.

In this manner, the first resistance heating body 91 having an area that is almost equal to the back surface 40A of the substrate 40 contacting the substrate loading surface 12A of the ceramic plate 12 is built in the ceramic plate 12. Therefore, the overall substrate 40 can be heated to a substantially uniform temperature.

By reference to FIG. 11, the electrode 92 is provided to pass through the portion of the ceramic plate 12 positioned below the first resistance heating body 91. The electrode 92 is connected to the first resistance heating body 91 and is connected electrically to the plus terminal 41A of the power supply 41.

The electrode 93 is provided to pass through the portion of the ceramic plate 12 positioned below the first resistance heating body 91. The electrode 93 is connected to the first resistance heating body 91 and is connected electrically to the minus terminal 41B of the power supply 41. The electrodes 92, 93 are the power-supplying electrodes to supply an electric power to the first resistance heating body 91.

The second resistance heating body 94 is built in the portion of the ceramic plate 12 positioned between the electrostatic electrode 13 and the first resistance heating body 91. The second resistance heating body 94 is constructed similarly to the third resistance heating body 71 explained in the third embodiment (see FIG. 8). The electrode 94 is formed like a ring shape and is provided to heat the substrate outer peripheral portion K. An interval J10 between the substrate loading surface 12A of the ceramic plate 12 and the upper surface of the second resistance heating body 94 can be set to 0.8 mm, for example.

In this manner, in addition to the first resistance heating body 91 for heating the whole area of the substrate 40, the second resistance heating body 94 for heating the substrate outer peripheral portion K is built in the ceramic plate 12. Therefore, for example, in the case where the substrate heating device 90 is employed in the plasma CVD apparatus, when a plasma density over the substrate outer peripheral portion K is low, the substrate outer peripheral portion K can be heated by the second resistance heating body 94 up to a temperature higher than other portions of the substrate 40. As a result, film quality of the film formed on the substrate 40 can be made substantially uniform not to depend on the plasma density.

The electrode 95 is provided to pass through the portion of the ceramic plate 12 positioned below the second resistance heating body 94. The electrode 95 is connected to the second resistance heating body 94 and is connected electrically to the plus terminal 75A of the power supply 75.

The electrode 96 is provided to pass through the portion of the ceramic plate 12 positioned below the second resistance heating body 94. The electrode 96 is connected to the second resistance heating body 94 and is connected electrically to the minus terminal 75B of the power supply 75. The electrodes 95, 96 are insulated electrically from the first resistance heating body 91. The electrodes 95, 96 are the power-supplying electrodes to supply an electric power to the second resistance heating body 94.

According to the substrate heating device of the present embodiment, the second resistance heating body 94 for heating the substrate outer peripheral portion K is built in the ceramic plate 12, in addition to the first resistance heating body 91 for heating the whole area of the substrate 40. Therefore, for example, in the case where the substrate heating device 90 is employed in the plasma CVD apparatus, when a plasma density over the substrate outer peripheral portion K is low, the substrate outer peripheral portion K can be heated by the second resistance heating body 94 up to a temperature higher than other portions of the substrate 40. As a result, film quality of the film formed on the substrate 40 can be made substantially uniform not to depend on the plasma density.

In the present embodiment, the case where one second resistance heating body 94 is built in the ceramic plate 12 is explained as an example. But one or plural resistance heating bodies may be provided in addition to the second resistance heating body 94.

Also, in the present embodiment, the case where the second resistance heating body 94 is built in the portion of the ceramic plate 12 positioned between the electrostatic electrode 13 and the first resistance heating body 91 is explained by way of example. But the second resistance heating body 94 may be built in the portion of the ceramic plate 12 positioned between the first resistance heating body 91 and the lower surface 12B of the ceramic plate 12.

### Sixth Embodiment

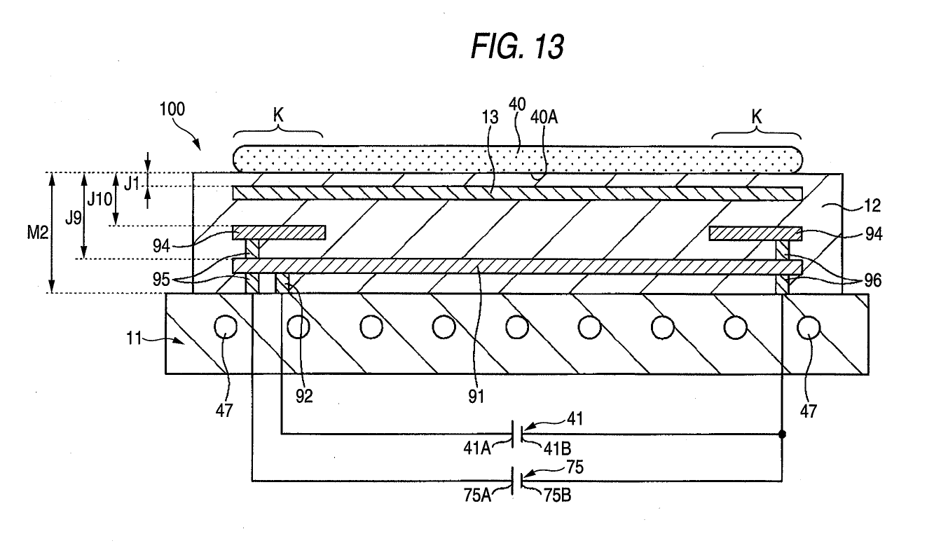

FIG. 13 is a sectional view of a substrate heating device according to a sixth embodiment of the present invention. In FIG. 13, the same reference symbols are affixed to the same constituent portions as the substrate heating device 90 according to the fifth embodiment.

By reference to FIG. 13, a substrate heating device 100 of the sixth embodiment is constructed similarly to the substrate heating device 90 of the fifth embodiment, except that the electrode 93 provided to the substrate heating device 90 of the fifth embodiment is removed and that the electrode 96 is connected to the first resistance heating body 91 and is connected electrically to the minus terminal 41B of the power supply 41. The electrode 95 is insulated electrically from the first resistance heating body 91.

According to the substrate heating device of the present embodiment, the electrode 96 is connected to the first resistance heating body 91 and is connected electrically to the minus terminal 41B of the power supply 41. Therefore, the number of electrodes 92, 95, 96 provided to the ceramic plate 12 can be reduced. As a result, a local temperature variation of the substrate 40 heated by the first resistance heating body 91 and the second resistance heating body 94 can be reduced.

In this case, when the electrode 92 provided to the substrate heating device 90 of the fifth embodiment is removed and also the electrode 95 is connected to the first resistance heating body 91 and is connected electrically to the plus terminal 41A of the power supply 41, the similar advantages as the present embodiment can be achieved.

### Seventh Embodiment

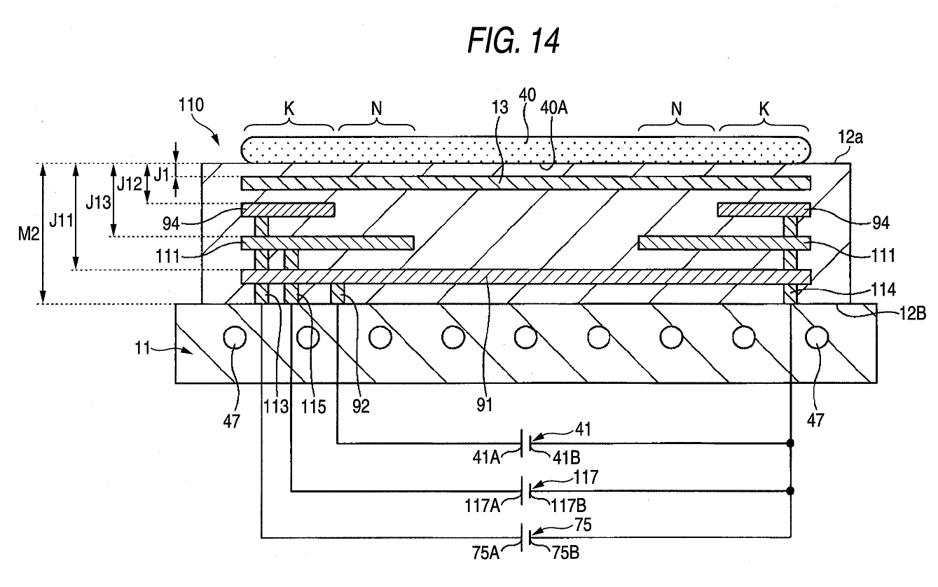

FIG. 14 is a sectional view of a substrate heating device according to a seventh embodiment of the present invention. In FIG. 14, the same reference symbols are affixed to the same constituent portions as the substrate heating device 100 according to the sixth embodiment.

By reference to FIG. 14, a substrate heating device 110 of the seventh embodiment is constructed similarly to the substrate heating device 90 of the fifth embodiment, except that the electrodes 95, 96 are removed from the configuration of the substrate heating device 100 of the sixth embodiment and that a third resistance heating body 111, electrodes 113 to 115, and a power supply 117 are provided.

The first resistance heating body 91 is built in the portion of the ceramic plate 12 positioned between the third resistance heating body 111 and the lower surface 12B of the ceramic plate 12. The first resistance heating body 91 is connected to the electrodes 92, 114 connected electrically to the power supply 41. The first resistance heating body 91 generates a heat from the electric power supplied from the power supply 41 via the electrodes 92, 114. An interval J11 between the substrate loading surface 12A of the ceramic plate 12 and an upper surface of the first resistance heating body 91 can be set to 1.8 mm, for example.

The second resistance heating body 94 is built in the portion of the ceramic plate 12 positioned between the electrostatic electrode 13 and the third resistance heating body 111. The second resistance heating body 94 is connected to the electrodes 113, 114 connected electrically to the power supply 75. The second resistance heating body 94 generates a heat from the electric power supplied from the power supply 75 via the electrodes 113, 114. An interval J12 between the substrate loading surface 12A of the ceramic plate 12 and an upper surface of the second resistance heating body 94 can be set to 0.8 mm, for example.

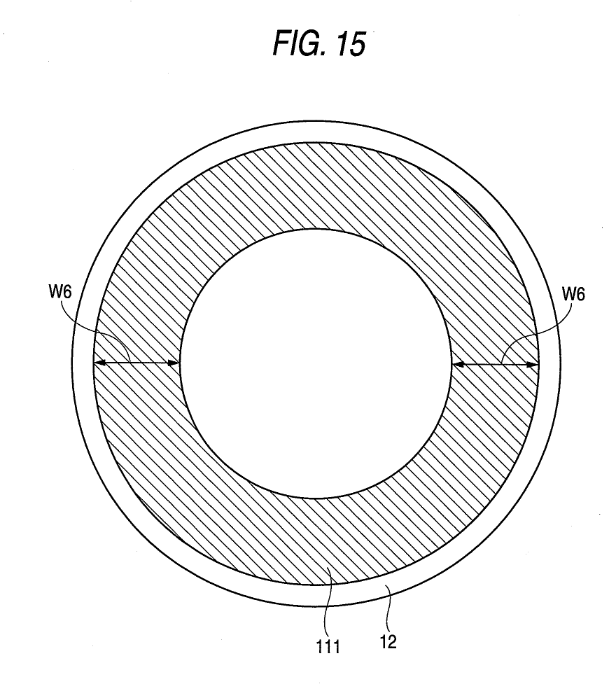

FIG. 15 is a plan view of a third resistance heating body provided to the substrate heating device shown in FIG. 14.

By reference to FIG. 14 and FIG. 15, the third resistance heating body 111 is built in the portion of the ceramic plate 12 positioned over the first resistance heating body 91 but below the second resistance heating body 94. The third resistance heating body 111 is formed like a ring shape whose width is larger than the second resistance heating body 94. When the width of the second resistance heating body 94 is 25 mm, a width W6 of the third resistance heating body 111 can be set to 50 mm, for example. An interval J13 between the substrate loading surface 12A of the ceramic plate 12 and the upper surface of the third resistance heating body 111 can be set to 1.3 mm, for example.

The third resistance heating body 111 is provided to heat the substrate outer peripheral portion K and a portion of the substrate 40 positioned inner than the substrate outer peripheral portion K (referred to as a “substrate portion N” hereinafter).

In this manner, in addition to the first resistance heating body 91 and the second resistance heating body 94, the third resistance heating body 111 for heating the substrate portion N that is positioned inner than the substrate outer peripheral portion K is built in the ceramic plate 12. Therefore, a temperature of three areas of the substrate 40 (the substrate outer peripheral portion K, the substrate portion N, and a portion of the substrate 40 positioned inner than the substrate portion N) can be changed respectively.

Therefore, for example, when the substrate heating device 110 is used in the plasma CVD apparatus in which a plasma density is increased toward a center from the outer periphery of the substrate 40, it is possible to provide a temperature gradient to the substrate 40. As a result, film quality of the film formed on the substrate 40 can be made substantially uniform independent of the plasma density.

By reference to FIG. 14, the electrode 113 is provided to pass through the portion of the ceramic plate 12 positioned below the second resistance heating body 94. The electrode 113 is connected to the second resistance heating body 94. Also, the electrode 113 is connected electrically to the plus terminal 75A of the power supply 75. The electrode 113 is insulated electrically from the first resistance heating body 91 and the third resistance heating body 111.

The electrode 114 is provided to pass through the portion of the ceramic plate 12 positioned below the second resistance heating body 94. The electrode 114 is connected to the first resistance heating body 91, the second resistance heating body 94, and the third resistance heating body 111. Also, the electrode 114 is connected electrically to the minus terminal 41B of the power supply 41, the minus terminal 75B of the power supply 75, and a minus terminal 117B of the power supply 117.

In this manner, the electrode 114 is connected to the first resistance heating body 91, the second resistance heating body 94, and the third resistance heating body 111 and also is connected electrically to the minus terminal 41B of the power supply 41, the minus terminal 75B of the power supply 75, and a minus terminal 117B of the power supply 117, so that the electrode 114 is used as the common electrode to the first resistance heating body 91, the second resistance heating body 94, and the third resistance heating body 111. Therefore, the number of electrodes 92, 95, 113 to 115 provided to the ceramic plate 12 can be reduced. As a result, a local temperature variation of the substrate 40 can be reduced.

The electrode 115 is provided to pass through the portion of the ceramic plate 12 positioned below the third resistance heating body 111. The electrode 115 is connected to the third resistance heating body 111. Also, the electrode 115 is connected electrically to a plus terminal 117A of the power supply 117. The electrode 115 is insulated electrically from the first resistance heating body 91.

According to the substrate heating device of the present embodiment, the third resistance heating body 111 for heating the substrate portion N that is positioned inner than the substrate outer peripheral portion K is built in the ceramic plate 12, in addition to the first resistance heating body 91 and the second resistance heating body 94. Therefore, for example, when the substrate heating device 110 is used in the plasma CVD apparatus in which a plasma density is increased toward a center from the outer periphery of the substrate 40, it is possible to provide a temperature gradient to the substrate 40. As a result, film quality of the film formed on the substrate 40 can be made substantially uniform not to depend on the plasma density.

Also, the electrode 114 is connected to the first resistance heating body 91, the second resistance heating body 94, and the third resistance heating body 111 and also is connected electrically to the minus terminal 41B of the power supply 41, the minus terminal 75B of the power supply 75, and a minus terminal 117B of the power supply 117, so that the electrode 114 is used as the common electrode to the first resistance heating body 91, the second resistance heating body 94, and the third resistance heating body 111. Therefore, the number of electrodes 92, 95, 113 to 115 provided to the ceramic plate 12 can be reduced. As a result, a local temperature variation of the substrate 40 can be reduced.

The preferred embodiments of the present invention are explained in detail as above. But the present invention is not such particular embodiments, and various variations and modifications can be applied within a scope of a gist of the present invention set forth in the claims.

According to the present invention, the substrate can be heated up to a predetermined temperature.

What is claimed is:

1. A substrate heating device, comprising:
a ceramic plate having a first main surface on which a substrate is loaded;
a plurality of first resistance heating bodies built in the ceramic plate, the plurality of first resistance heating bodies being arranged on a same planar surface in substantially parallel with the first main surface of the ceramic plate such that adjacent first resistance heating bodies are separated mutually, the plurality of first resistance heating bodies being constructed such that a temperature is controlled independently respectively; and
at least one second resistance heating body built in the ceramic plate to heat portions of the ceramic plate positioned between the plurality of first resistance heating bodies.

2. A substrate heating device according to claim 1, wherein the second resistance heating body is arranged between the first main surface of the ceramic plate and the first resistance heating bodies or between a surface of the ceramic plate on an opposite side to the first main surface and the first resistance heating bodies.

3. A substrate heating device according to claim 1, further comprising:
a third resistance heating body built in the ceramic plate, wherein the third resistance heating body is arranged in a predetermined position.

4. A substrate heating device according to claim 3, further comprising:
two power-supplying electrodes built in the ceramic plate and connected to the third resistance heating body,
wherein any one of two power-supplying electrodes is provided to pass through a portion of the ceramic plate positioned between the first resistance heating bodies or the second resistance heating body and the third resistance heating body, and is connected to the first resistance heating bodies or the second resistance heating body.

5. A substrate heating device according to claim 1, wherein an electrostatic electrode is built in the ceramic plate.

6. A substrate heating device according to claim 1, further comprising:
a plurality of power-supplying electrodes built in the ceramic plate and connected to the respective first resistance heating bodies.

7. A substrate heating device, comprising:
a ceramic plate on which a substrate is loaded; and
a resistance heating body built in the ceramic plate to heat the ceramic plate;
wherein the resistance heating body includes
a first resistance heating body having an area that is substantially equal to a surface of the substrate contacting a first main surface of the ceramic plate, and arranged in substantially parallel with the first main surface of the ceramic plate, and
a second resistance heating body arranged in a predetermined position between the first main surface of the ceramic plate and the first resistance heating body or between a surface of the ceramic plate on an opposite side to the first main surface and the first resistance heating body.

8. A substrate heating device according to claim 7, further comprising:
a first power-supplying electrode built in the ceramic plate and connected to the first resistance heating body; and
a second power-supplying electrode built in the ceramic plate and connected to the second resistance heating body;
wherein a first electrode is provided to pass through a portion of the ceramic plate positioned between the first resistance heating body and the second resistance heating body.

9. A substrate heating device according to claim 7, further comprising:
two power-supplying electrodes built in the ceramic plate and connected to the second resistance heating body;
wherein any one of two power-supplying electrodes is provided to pass through a portion of the ceramic plate positioned between the first resistance heating body and the second resistance heating body, and is connected to the first resistance heating body.

10. A substrate heating device according to claim 7, wherein an electrostatic electrode is built in the ceramic plate.
